(19) United States
(12) Patent Application Publication
(10) Pub. No.: US 2004/0245728 A1
(43) Pub. Date: Dec. 9, 2004

(54) Lip seal

(76) Inventors: James Edward Gordon Armour, Surrey (GB); Alon Hankin, Cumbria (GB); Godfrey Duncan Elliott, Surrey (GB)

Correspondence Address: HODGSON RUSS LLP, ONE M & T PLAZA, SUITE 2000, BUFFALO, NY, 14203-2391, US

(21) Appl. No.: 10/808,956

(22) Filed: Mar. 25, 2004

(30) Foreign Application Priority Data
Mar. 26, 2003 (GB) 0306963.0
Mar. 31, 2003 (GB) 0325507.2

(51) Int. Cl. F16J 15/32; F16J 15/34

(52) U.S. Cl. 277/549

(57) ABSTRACT

A lip seal comprises resilient annular sealing means 2, 3, having a sealing lip 4 adapted for sealing engagement at an end 9 thereof with a relatively movable shaft and a valve lip 6, the lips being, in use, normally closed, and means 11, 13, for injecting fluid into a space 7 between the closed lips 4, 6 at sufficient pressure to cause the lips to open during use to allow the fluid to flow towards the end 9 of the sealing lip 4.

### BACKGROUND OF THE INVENTION

The invention relates to a lip seal, for example, in the form of an elastomeric annular ring, used either singly or in an arrangement of two or more units, to seal the space between two relatively movable coaxial members for example a rotating shaft and a stationary member surrounding the shaft. Typical applications include mineral extraction and processing, shallow water dredging and tunnel boring.

Traditional sealing arrangements for highly abrasive media generally consist of a number of basic u-ring type lip seals manufactured from either a rubber proofed fabric composite material, a suitable elastomeric compound or a combination of both. In order to protect the dynamic interface between the sealing edge of the lip and the rotating shaft from excessive wear associated with the build up of abrasive material at this point, a suitable fluid, usually a grease, is pumped between the shaft and the sealing lip to wipe away the debris.

In addition to the abrasive nature of the media encountered in applications of this type, the media may be pressurized to levels far above that which a single rotary lip seal can withstand without damage. To overcome this problem, the environmental pressure is reduced in stages across a number of separate seals. To achieve this a lubricating fluid, such as grease or oil, is injected at a controlled pressure through the seal housing and lantern rings into each inter-seal cavity to provide a support to the sealing lips, reducing the differential pressure per seal to an acceptable level.

FIG. 4 shows a traditional abrasive media sealing arrangement consisting of a number of specialized abrasion resistant seals 17, facing the medium, which may be used in conjunction with standard spring energized seals 18. Although these seals 18 are capable of sealing higher differential pressures they exhibit poor abrasion resistance. One of these 19 may face away from the medium to seal gear oil.

A suitable lubricating medium is injected though each housing port 11 and lantern ring 20 into the inter-seal cavities 21,22,23,24 at a controlled pressure. The first port 25 is used to inject a medium at a pressure greater than environmental pressure into the first inter-seal cavity 21 in order to flush beneath the sealing lip 46 of the first seal in the arrangement 29. Subsequent ports 26,27,28 are used to inject a medium through the lantern rings 20 and into the inter-seal cavities 22,23,24 at a pressure sufficient to support the sealing lips of the remaining seals 30,31,32,46 at a differential pressure below the maximum differential pressure for that particular design of seal.

There are serious limitations to traditional sealing systems of this type:

1) Debris can accumulate and become compacted in the groove of the seal. This limits the flexibility of the seal lip, increasing frictional heat generation and reducing the life of the seal.

2) Existing abrasive media seals are designed either with highly flexible sealing lips to accommodate large degrees of shaft offset, but reducing differential pressure capability, or less flexible lips capable of higher pressures but lower shaft offset,

3) Traditional sealing arrangements, consisting of a number of seals and separate lantern rings, require a minimum axial housing volume to be made available in the machine, dependant on environmental pressure. The greater the axial volume required, the higher the costs of manufacturing the machine.

4) Machines with a pre-determined amount of space available for a sealing arrangement will be restricted to operating at limited environmental pressures, dictated by the maximum number of seals and lantern rings that can be accommodated.

### SUMMARY OF THE INVENTION

In at least one of its preferred embodiments, the present invention is intended to overcome the above problems.

One aspect of the present invention provides a lip seal having a sealing lip adapted for sealing engagement at an end thereof with a relatively movable surface to separate a sealed region from an unsealed region, and a shield coextensive with the sealing lip on the unsealed side thereof to protect the sealing lip from the unsealed region and to define a space with the lip, and means permitting the injection under pressure of fluid into the space, the shield having an end disposed such that the fluid exits the space by passing between the lip end and the shield end into the unsealed region.

Another aspect of the present invention provides a lip seal comprising resilient sealing means having a sealing lip adapted for sealing engagement at an end thereof with a relatively movable surface, a shield lip, the sealing and shield lips being normally closed together, and means permitting injection of fluid between the closed lips at sufficient pressure to cause the lips to open during use to allow the fluid to flow towards the end of the sealing lip.

In a further aspect a seal assembly consists of at least one lip seal as set forth above disposed between relatively movable parts to define a sealed and an unsealed region. The most common form of seal in which the invention may be used is an annular seal for installation between relatively rotatable substantially coaxial parts eg a shaft passing through a housing. Thus the seal may be held statically in a rigid housing bore through a combination of an interference fit on the outer diameter of the seal and a designed axial compression of the seal. Sealing of a rotating shaft is effected by an interference fit of the primary sealing lip on the shaft plus pressurisation of the lip on to the shaft by the injected fluid. The pressure of the injected fluid must exceed that of the ambient environment into which the fluid passes to enable it to exit the space between the lip and the shield.

It will be appreciated that the seal assembly may be provided between a stationary shaft and a structure rotatable thereon, or indeed between two parts both of which may rotate. It also may be used where there is relative linear (eg reciprocating) motion between the two parts, either instead of or in addition to rotary motion. The invention can also be used in a face seal between two relatively movable radially extending surfaces and in applications in which the seal is not of annular shape eg between relatively sliding surfaces which are not bodies of rotation. The invention may also be used in “split seals” in which the ends of a length of profiled sealing material are joined to form an annular seal.

Thus in general any of these arrangements results in the sealing lip being in sealing engagement with a surface with which it has relative rotational and/or linear motion. Such a surface is referred to herein for convenience as a “relatively movable surface” or a “relatively moving surface” even if in a particular case the surface is stationary and it is the sealing lip which is moving.

Accordingly, in another aspect the invention provides use of a pressurized flow of fluid directed along an external surface of a sealing lip according to previously described aspects of the invention towards an end thereof in sealing engagement with a relatively moving surface to remove debris accumulated at the end of the sealing lip.

In one form, the sealing means comprises a first member having the lip and a second member having the shield. The first member may comprise a further shield positioned on a side of the lip opposite the second member. Preferably, the second member comprises a further lip positioned on a side of the shield remote from the first member. Preferably, the first member is unitary with its lip and further shield, and the second member is unitary with its shield and further lip.

The requirement for a continuous purge of a grease or other suitable fluid medium to remove abrasive debris from the sealing lip/shaft interface is met by an internal flush system. The medium may be injected through the centre of the seal and vented between the primary sealing lip and a secondary valve or vent lip which acts as a flexible valve or throttle, in positive contact with the primary sealing lip when not pressurised. These two lips meet in such a way that the venting occurs in a region adjacent to the sealing lip/shaft interface.

The primary sealing lip is forced towards the vent lip under normal operating conditions, forming a fluid-tight seal in one direction of fluid-flow, and is lifted from it only by the grease venting across the end of the primary sealing lip. The vent lip therefore forms a barrier, not allowing abrasive debris to reach the internal envelope of the seal, protecting the groove of the primary sealing lip from the ingress and subsequent compaction of the debris. The geometry of the top surface of the primary sealing lip is designed such that the vent lip rides smoothly over it under shaft offset conditions, maintaining contact at all times.

The self-venting functionality of the invention can facilitate a reduction in the number of units required to seal against a given ambient or environmental pressure when compared with traditionally vented systems. Traditional arrangements require the venting medium to be introduced through a lantern ring into the cavity between the primary and secondary seal. In this way, the medium may be pumped underneath the sealing lip of the primary seal at a pressure sufficient to overcome both the environmental pressure acting on the sealing lip and also the interference between the sealing lip and the shaft. The main implication of this venting method is that the pressure in the first inter-seal cavity must be greater than the environmental pressure to achieve venting. This higher pressure must then be stepped down across a number of subsequent seals, at an acceptable differential pressure per unit. The invention employs an internal venting system. This means that the medium injected into the first inter-seal cavity need only be at a pressure high enough to support the sealing lip of the primary sealing lip onto which the pressure of the venting medium, being injected through the seal, is acting. The pressure in the first inter-seal cavity will therefore be significantly lower than the environmental pressure and within the differential pressure capability of the primary seal.

As the pressure required in the first inter-seal cavity is lower, so fewer seals are required to step it down. For a given environmental pressure, fewer units will be required than would be for a traditional sealing arrangement. This has the benefit of reducing equipment/machine manufacturing costs and allowing existing machines to be operated at higher environmental pressures with only minor modification.

In traditional abrasive media seal designs the lip can be very flexible to accommodate high levels of shaft offset. These long, flexible sealing lips present a large area to applied fluid pressure. The sealing lips may be flattened onto the shaft if a modest pressure is exceeded, increasing contact area and frictional heat generation. This could lead to premature seal failure and so maximum differential pressures are strictly limited. The invention can retain the shaft offset accommodation of the long, flexible lip design, while reducing the area exposed to applied fluid pressure—the vent lip presenting a much smaller area than the primary sealing lip. This can allow a higher differential pressure per seal.

The metallic rings used to separate the seals in a traditional sealing arrangement must contain the grooves and holes necessary to carry the injected medium from the housing into the inter-seal cavity. These design restrictions impose a minimum axial depth on these rings. The rings which separate the seals in an arrangement containing multiple units of the invention are essentially spacer rings, containing no holes or grooves, and so the axial length of these rings may be reduced significantly, saving on axial space and therefore manufacturing costs.

The reinforced elastomeric compound preferably utilized in the invention resists the extension of the seal under its own weight during fitting. This can occur at larger diameters where the seal diameter to cross-sectional area ratio is high. Unlike traditional rubber proofed fabric composite materials, this reinforced elastomeric compound can be easily joined to form complete endless rings when seal diameters are so large that manufacturing limitations allow only split seals to be moulded. This can offer a significant benefit over large abrasive media seals containing rubber proofed fabric which can tend to split during fitting or in service due to join weakness.

Another aspect of the invention provides an element for use in a lip seal of previously described aspects, the element comprising:

a body portion;

a sealing lip depending from the body portion, the sealing lip being adapted for sealing engagement at an end thereof with a relatively movable surface to separate a sealed region from an unsealed region; and

a shield depending from the body portion, the shield being coextensive with the sealing lip and being disposed on the sealed side of the sealing lip, the element being configured to abut a further said element so that the shield provides, with the lip of the further element, a lip seal as set forth above.

Another aspect of the invention provides a method of protecting a lip seal from contamination, the lip seal comprising resilient sealing means having a sealing lip adapted for sealing engagement at an end thereof with a relatively moving surface, the method comprising providing a shield coextensive with the sealing lip, the shield, allowing fluid injected into a space between the lip and the shield to exit the space by passing between the lip end and an end of the shield.

A further aspect is the use of a pressurized flow of fluid directed along an unsealed surface of a sealing lip towards an end thereof in sealing engagement with a relatively moving surface (as herein defined) to remove debris accumulated at the end of the sealing lip.

Other advantageous features are as set out in the dependent claims, the description given below and the appended drawings.

Preferred features of the present invention will now be described with reference to the accompanying drawings, in which:

### BRIEF DESCRIPTION OF THE DRAWINGS

FIG. 1 shows a cross section of an annular seal according to an embodiment of the present invention;

FIG. 2 shows a cross section of the seal illustrated in FIG. 1 fitted into a suitable housing;

FIG. 3 shows a plan view demonstrating how the internal ports of the seal illustrated in FIG. 1 would typically be distributed;

FIG. 4 shows a typical traditional sealing arrangement for a high pressure abrasive medium application;

FIG. 5 shows a sealing arrangement for the same high pressure application using the seal of FIG. 1; and

FIG. 6 shows another sealing arrangernent for the same high pressure application using an alternative embodiment of the seal according to the present invention.

### DETAILED DESCRIPTION OF THE INVENTION

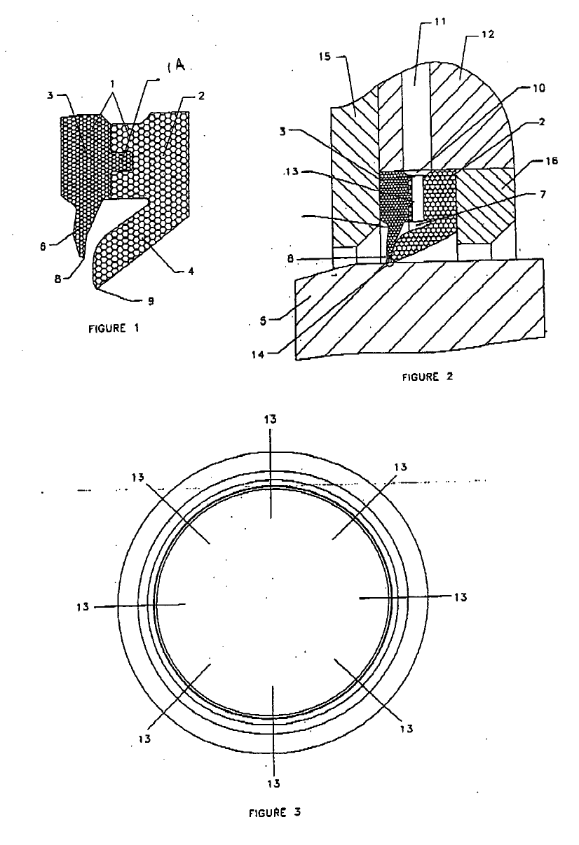

With reference to FIG. 1, one preferred embodiment of the lip seal according to the present invention consists of an element having first and second resilient annular members in the form of a two-piece annular ring 1, one component 2 being manufactured from a suitable elastomeric compound and the second 3 from a reinforced elastomeric compound.

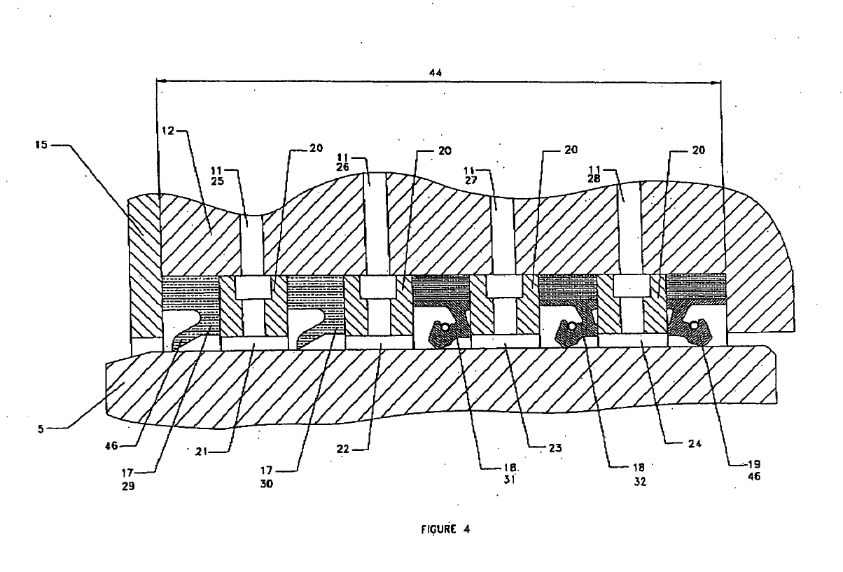

The elastomeric component 2 incorporates a sealing lip in the form of a primary sealing lip 4 which has an interference fit on a shaft 5, as illustrated in FIG. 2. The reinforced elastomeric component 3 is securely fixed to this by a flange and groove 1A and incorporates a shield in the form of a secondary vent lip 6 which encloses a space or groove 7 of the primary sealing lip 4 when fitted in a housing 12. The inner diameter 8 of the vent lip 6 rests radially close to the sealing edge 9 of the primary lip 4 when fitted to the shaft 5.

The reinforced nature of the compound of the second component 3 can aid in installing the seal on the shaft 5. In one alternative embodiment, components 2 and 3 are homogenous, being made from the same compound, preferably either an elastomeric or reinforced elastomeric compound.

The lip seal is configured to allow either the shaft 5 to be rotatable therein, or the lip seal to be rotatable on the shaft 5. Alternatively or in addition the shaft may be movable axially, or linearly, with respect to the lip seal, such as in an axial reciprocating motion.

On the outer diameter of the seal is located an endless circumferential groove 10. This is designed to coincide axially with ports 11 in the seal housing 12 through which a suitable medium is injected at a controlled pressure. This medium is then allowed to flow around this circumferential groove 10, and through equally spaced ports 13 within the body of the seal to allow the medium to flow circumferentially around the enclosed space formed by the groove 7 and the lips 4, 6. The pressure forces the vent lip 6 to flex allowing the medium to flow into the sealing zone 14, removing abrasive debris. Also, the vent lip 6 prevents contaminant such as unwanted or used lubricant, for example, from returning, or moving back past the vent lip 6 to the primary lip 4. The body of the ring 1 is retained between a front plate 15 and a spacer ring 16.

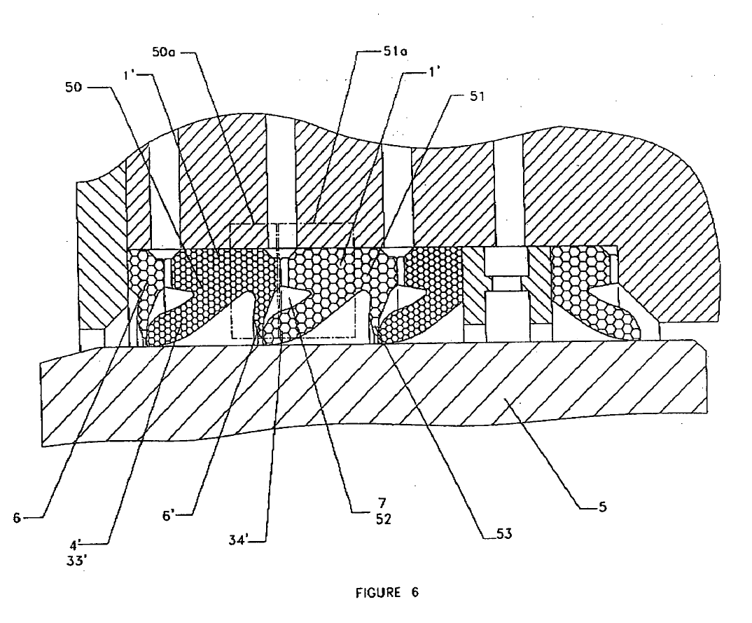

For a sealing arrangement comprising multiple units of the invention three forward facing seals 33,34,35 may be provided in addition to one rear facing unit 36 to seal gear oil, as per FIG. 5. A suitable medium is injected through the primary seal 33, via the first housing port 37 at a pressure above environmental pressure to effect a flush. Subsequent ports 38,39 are used to inject a lubricating medium through the secondary and tertiary seals 34,35 and into the inter-seal cavities 41,42 to support the sealing lips 4 of the primary and secondary seals 33,34. The last port 40 is used to introduce an amount of non-pressurized lubricating medium into the inter-seal cavity 43 to aid lubrication of the tertiary forward facing seal 35 and the rear facing seal 36. In use, the environmental pressure is stepped down in stages from seal 33 to 36 to ensure the pressure provided by the injecting fluid combined with back pressure from existing fluid and debris does hot cause failure of any seal 33, 34 and 35. This is achieved through known methods of injecting fluid at controlled pressures.

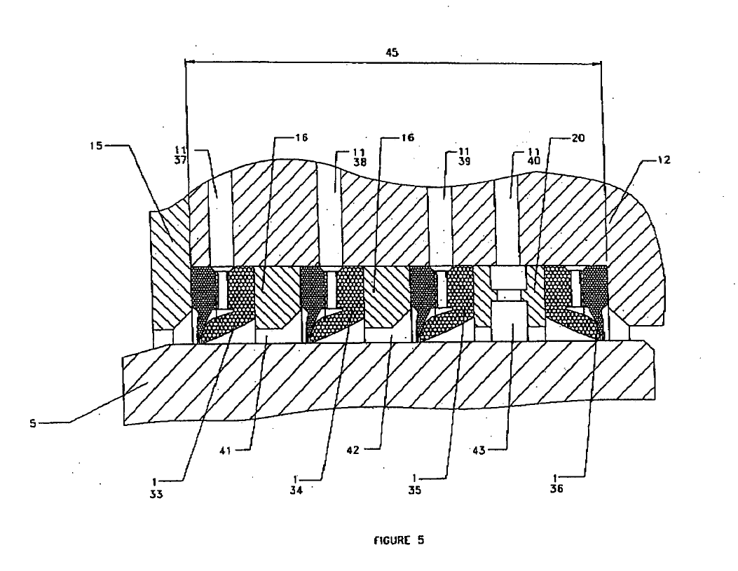

The functionality of the invention, in addition to the simplified, shallower spacer rings 16, has enabled the housing length 44 (FIG. 4) required for a traditional arrangement at a given environmental pressure to be reduced significantly as seen at 45 (FIG. 5) for a sealing arrangement based upon the invention, at the same external pressure.

FIG. 6 illustrates an alternative embodiment of the seal according to the invention in use, where like reference numerals denote like parts. In this embodiment, in use, the principles of operation are the same as for the embodiment described above in reference to FIG. 5. The differences lie in that the element is in the form of a unitary annular ring 1′. Unlike the previously described embodiment, the primary lip 4′ and vent lip 6′ depending from an outer body portion 50 or 51 do not together form the space or groove 7. Instead, as illustrated in FIG. 6, the groove 7 is formed between primary and vent lips of adjacent annular rings 1′. For example, groove 52 is formed between primary lip 34′ and vent lip 6′.

In keeping with the spirit of the invention, the sealing means in this embodiment may alternatively be considered as having two resilient annular members in the form of two body portions 51a and 50a which have a respective primary lip 34′ and vent lip 6′, where the primary and vent lips 34′ and 6′ together define the groove 7. In another alternative construction, the resilient annular sealing means may be considered as being in the form of two body portions 50 and 51, from which depend respective primary and vent lips 34′ and 6′ together defining the groove 7. In this construction, another vent lip 53 depends from body portion 51 on a side of primary lip 34′ being opposite body portion 50, and another primary lip 33′ depends from body portion 50 on a side of the vent lip 6′ being opposite body portion 51.

As illustrated in FIGS. 2, 3, 5 and 6, the seals 33 to 36 are arranged in an axial orientation with respect to the shaft 5. In an alternative embodiment of the invention however the lip seals 33 to 36 are arranged as a face seal, being orientated in a radial direction with respect to the shaft 5. In another alternative embodiment, the lip seals 33 to 36 extend, radially outwardly from a body portion for use in applications such as within a hollow shaft.

While the present invention has been described in its preferred embodiments, it is to be understood that the words which have been used are words of description rather than limitation and that changes may be made to the invention without departing from its scope as defined by the appended claims.

Each feature disclosed in this specification (which term includes the claims) and/or shown in the drawings may be incorporated in the invention independently of other disclosed and/or illustrated features.

1. A lip seal having a sealing lip adapted for sealing engagement at an end thereof with a relatively movable surface to separate a sealed region from an unsealed region, and a shield coextensive with the sealing lip on the unsealed side thereof to protect the sealing lip from the unsealed region and to define a space with the lip, and means permitting the injection under pressure of fluid into the space, the shield having an end disposed such that the fluid exits the space by passing between the lip end and the shield end into the unsealed region;

2. A lip seal according to claim 1, wherein, during normal use, the shield contacts the sealing lip proximate the end thereof, the fluid being injected at sufficient pressure to cause the shield to flex to allow the fluid to flow towards the end of the sealing lip.

3. A lip seal according to claim 1, wherein the sealing means comprises a first resilient member having said sealing lip and, adjacent to the first annular member, a second resilient member having said shield.

4. A lip seal according to claim 3, wherein the first member comprises a further shield, the further shield being positioned on the sealed side of the lip.

5. A lip seal according to claim 3, wherein the second member comprises a further lip, the further lip being positioned on a side of the shield remote from the first member.

6. A lip seal according to claim 3, wherein the second member is formed from a reinforced elastomer.

7. A lip seal according to claim 3, wherein the first and second members are annular.

8. A lip seal according to claim 7, wherein the sealing means comprises an outer diameter body portion from which the lip and shield extend radially inwardly.

9. A lip seal according to claim 8, wherein the body portion is adapted for retention within a housing of a bore for a shaft.

10. A lip seal according to claim 1, wherein the means permitting injection is arranged to admit fluid between the shield and a grooved portion of the sealing means which defines in part the sealing lip.

11. A lip seal according to claim 1, wherein the sealing means comprises at least one port extending through the sealing means and through which the inject fluid is injected.

12. A lip seal according to claim 7, wherein the means permitting injection is arranged to admit fluid between the shield and a grooved portion of the sealing means which defines in part the sealing lip, and the at least one port extends between the first and second annular members.

13. A lip seal comprising resilient sealing means having a sealing lip adapted for sealing engagement at an end thereof with a relatively movable surface, a shield lip, the sealing and shield lips being normally closed together, and means permitting injection of fluid between the closed lips at sufficient pressure to cause the lips to open during use to allow the fluid to flow towards the end of the sealing lip.

14. A seal assembly comprising at least one lip seal according to claim 1, disposed between relatively movable parts to define a sealed and an unsealed region.

15. A seal assembly according to claim 14, wherein the relatively movable parts are substantially coaxial and are relatively movable by rotation and/or translation about or along said axis.

16. A seal assembly according to claim 15, comprising a plurality of lip seals according to claim 1 axially spaced along the axis of the relatively movable parts.

17. An element for use in a lip seal comprising:
a body portion;
a sealing lip depending from the body portion, the sealing lip being adapted for sealing engagement at an end thereof with a relatively movable surface to separate a sealed region from an unsealed region; and
a shield depending from the body portion, the shield being coextensive with the sealing lip and being disposed on the sealed side of the sealing lip, the element being configured to abut a further said element so that the shield provides, with the lip of the further element, a lip seal according to claim 1.

18. Use of a pressurized flow of fluid directed along an external surface of a sealing lip according to claim 1, towards an end thereof in sealing engagement with a relatively moving surface (as herein defined) to remove debris accumulated at the end of the sealing lip.

19. A method of protecting a lip seal from contamination, the lip seal comprising resilient sealing means having a sealing lip adapted for sealing engagement at an end thereof with a relatively moving surface, the method comprising providing a shield coextensive with the sealing lip, the shield allowing fluid injected into a space between the lip and the shield to exit the space by passing between the lip end and an end of the shield.

20. The method of claim 19 wherein the shield restricts material from crossing the shield end into the space.
